(19) United States
(12) Patent Application Publication
(10) Pub. No.: US 2026/0346821 A1
(43) Pub. Date: Nov. 5, 2026

(54) METHOD FOR OPERATING A MOTOR VEHICLE, COMPUTER PROGRAM PRODUCT, STORAGE MEDIUM, COMPUTER DEVICE

(71) Applicant: Robert Bosch GmbH, Stuttgart (DE)

(72) Inventor: Markus Glaser, Sindelfingen (DE)

(21) Appl. No.: 19/411,792

(22) Filed: Dec. 8, 2025

(30) Foreign Application Priority Data
Dec. 10, 2024 (DE) 10 2024 211 741.2

(51) Int. Cl. B60T 8/1761; B60T 8/1755; B60T 8/34; B60W 10/18; B60W 30/02; B60W 30/14

(52) U.S. Cl. CPC B60T 8/1761; B60T 8/17551; B60T 8/344; B60W 10/18; B60W 30/02; B60W 30/146; B60T 2270/306; B60W 2520/26

(57) ABSTRACT

A method for operating a motor vehicle. The motor vehicle includes at least one axle with at least one wheel. The wheel is assigned an electric drive device having an actuatable first actuator arrangement including an electric machine, and the wheel is assigned a hydraulic wheel braking device having an actuatable second actuator arrangement in particular including an electric machine, which is assigned to a hydraulic pump, and/or a hydraulic valve arrangement. Each of the actuator arrangements is assigned at least one, wheel-specific, slip limit value and the actuator arrangements are actuated depending on the specified slip limit values, for fulfilling a brake request.

### FIELD

The present disclosure relates to a method for operating a motor vehicle, wherein the motor vehicle comprises at least one axle with at least one wheel, wherein the wheel is assigned an electric drive device having an actuatable first actuator arrangement comprising an electric machine, and wherein the wheel is assigned a hydraulic wheel braking device having an actuatable second actuator arrangement in particular comprising an electric machine, which is assigned to a hydraulic pump, and/or a hydraulic valve arrangement.

Furthermore, the present disclosure relates to a computer program product that performs the above method when the computer program product is executed on a computer device. In addition, the present disclosure relates to a machine-readable storage medium with such a computer program product and to a computer device which is specifically configured to execute the computer program product or to perform the aforementioned method.

### BACKGROUND INFORMATION

Certain motor vehicles with hydraulic wheel braking devices and vehicle dynamics control systems are described in the related. Today's vehicle dynamics control systems typically comprise a vehicle dynamics control device and brake hydraulics. The brake hydraulics is connected to wheel brake cylinders of the wheel braking devices via brake lines. The brake pressure in the wheel brake cylinders can be adjusted via various valves and a hydraulic pump.

For example, Germany Patent Application No. DE 43 05 155 A1 describes such a vehicle dynamics control system. It describes how the vehicle dynamics controller interacts with the brake hydraulics. The vehicle dynamics controller substantially consists of a yaw velocity controller. From a measurement data acquisition, the yaw velocity controller receives a yaw velocity signal, wheel velocity signals for forming the vehicle velocity, a steering angle signal, and a lateral acceleration signal. The yaw velocity controller forms a target profile of the yaw velocity with the aid of the measurement signals and physical models for the yaw motion of the vehicle. Depending on the driving situation, the yaw velocity controller generates a hydraulic brake intervention for stabilizing the vehicle. For this purpose, the instantaneous target wheel slip is increased or decreased by a subordinate wheel controller, or the target wheel brake pressure is changed by the output of valve opening times of the brake hydraulics.

The continuous development of vehicle dynamics control systems has resulted in the yaw velocity controller as well as further functions. These include rollover prevention, which is also called rollover mitigation (ROM) or roll movement intervention (RMI), and trailer stabilization, which is also called trailer sway mitigation (TSM). All of these functions are now part of the lateral dynamic stabilization functions of a vehicle dynamics control system and all of them use brake hydraulics to generate a hydraulic brake intervention for stabilizing the vehicle. The continuously advancing electrification of vehicles results in drive concepts with wheel-specific electric motors.

These electric motors can generate drive torques as well as braking torques. If both actuators, i.e., the hydraulic wheel brake and the electric drive motor, are installed on a wheel of the vehicle, both can be used by the lateral dynamic stabilization functions for generating a brake intervention in the event of stabilization of the vehicle.

### SUMMARY

In an example method according to the present disclosure, each of the actuator arrangements is assigned at least one, in particular wheel-specific, slip limit value, and the actuator arrangements are actuated depending on the specified slip limit values, for fulfilling a brake request. As described above, vehicle dynamics control systems typically use hydraulic wheel brakes for stabilizing the motor vehicle. However, other brake variants are also possible, for example electromechanical brakes. As provided according to the present disclosure, if the motor vehicle has a further actuator at the particular wheel, in the present case an electric drive motor, the stabilization task can be achieved by optimally actuating the resulting wheel combination actuator, which comprises the wheel brake and the drive motor. This advantageously ensures that the two actuator arrangements are optimally included and used in the vehicle dynamics control as part of a slip control when fulfilling a brake request. In particular, the brake request is detected and/or ascertained by means of a sensor arrangement and specified and/or received by an actuating device and/or a control unit. In this respect, the present disclosure provides a control strategy in which both actuator arrangements are optimally actuated together in order to generate a braking torque at the corresponding wheel. In particular, this involves the division of the braking torque into a hydraulic braking torque and an electrical braking torque and to the necessary wheel slip monitoring. Especially for wheel slip monitoring, the present disclosure provides in particular a possibility of how this task can be achieved by a subordinate wheel controller via the, in particular hydraulic, brake and by a speed controller via the electric drive motor. The slip limit values provided according to the present disclosure are used for this purpose. It should be noted here, merely as a precautionary measure, that the below numbering of the slip limit values serves only to differentiate them and not to prioritize them or specify them, and does not imply any necessary dependence of the limit values on one another. According to the present disclosure, only two different slip limit values must be used, one of which is assigned to at least the first actuator arrangement and another is assigned to at least the second actuator arrangement so that it is reliably defined which of the two actuator arrangements is actuated and used when and how as part of the method according to the present disclosure. For example, the limit values described below as the third and fourth slip limit values are used as a minimum requirement for this purpose. This results in prioritization of the first actuator arrangement so that a braking torque is preferably provided and controlled as predominantly as possible, in particular exclusively, by means of the first actuator arrangement. The order of the resulting braking torque distribution, which is described in more detail below by way of example, has advantages with regard to the comfort and timing of the vehicle stabilization. The actuation of the electric drive motor during the vehicle stabilization can begin earlier and can take place in a vehicle motion range that is still outside the lateral dynamic (yaw rate control) and rollover-critical (rollover prevention) range. These ranges are not possible from a hydraulic point of view in terms of driving comfort since there are always noises due to the hydraulic pump and the switching of valves within the brake hydraulics when the hydraulic brake is actuated. The continuous perceptibility of the lateral dynamic stabilization function by the driver in a rather non-critical vehicle motion range significantly reduces driving comfort. Another advantage of the prioritized use of the first actuator arrangement is the improvement in the control quality when adjusting the wheel slip. For example, a high cycle time in the range of milliseconds, in particular of 1 ms, for a speed control of the electric machine allows for better wheel slip controls, especially in the unstable slip range of the wheel. This benefits not only the yaw rate control but also the rollover prevention, which is significantly more frequently confronted with strong vehicle body motion. This results in strong wheel load fluctuations, which in turn have a strong influence on the wheel slip behavior. In summary, the advantages of the approach according to the present disclosure of a slip-value-dependent actuation of the wheel combination actuator are the optimal distribution of the braking torque fractions to the, in particular hydraulic, brake and the electric drive motor for improving the comfort and timing of the vehicle stabilization, as well as the improvement in the wheel slip control with regard to the control quality because this occurs in a prioritized manner via the speed control of the electric drive motor. The use provided according to the present disclosure of the appropriate actuator-specific slip limit values represents a particularly advantageously simple and elegant solution for robustly implementing this prioritization.

According to a preferred development of the present disclosure, at least one of the slip limit values is specified depending on a performance capability of the corresponding actuator arrangement and/or on a driving mode of the motor vehicle, in particular comprising a comfort mode and/or a sports mode. Specifying the particular slip limit value in such a performance-dependent and/or mode-dependent manner advantageously ensures that the particular slip limit value is optimally adapted to a state of health of the corresponding actuator arrangement and/or the driving behavior desired by the particular driver. For example, the corresponding slip limit value is selected such that, when the performance capability of one of the actuator arrangements is reduced, the other actuator arrangement will assume a higher fraction of a braking torque to be provided for fulfilling the brake request. Likewise, for example, in a sports mode, a higher slip limit value than in a comfort mode is specified or a higher wheel slip is allowed before, for example, a corresponding active slip control is carried out. In particular, at least one of the slip limit values is defined at a specified safety distance to and/or in a particular range, for example up to 50%, 75%, or 90%, of the maximum performance capability in order not to load the actuator arrangement excessively.

According to an example embodiment, particularly preferably, an actual slip value of the wheel slip is ascertained, and only the first actuator arrangement is initially actuated depending on the actual slip value, in particular by means of a speed control of the electric machine, for generating an electrical braking torque. Such an actuation results in the advantage that the first actuator arrangement is used in a prioritized manner. In particular, an attempt is initially made to provide a necessary braking torque to be provided to fulfill the brake request exclusively by means of the first actuator arrangement, in particular by operating the electric machines in a generator mode or regenerative mode. The second actuator arrangement is then engaged only as needed.

According to a preferred development of the present disclosure, a first slip limit value is specified and assigned to the second actuator arrangement and, if the actual slip value at least reaches, in particular exceeds, the first slip limit value, the second actuator arrangement, in particular the electric machine assigned to the hydraulic pump, is additionally actuated for prefilling a hydraulic circuit of the wheel braking device. The corresponding specification and use of the first slip limit value advantageously ensures that the second actuator arrangement is ready in time for generating a braking torque, for example if the actual slip value continues to increase. In this respect, the response time for actuating the second actuator arrangement is advantageously further reduced. However, this is not mandatory for the method according to the present disclosure.

Particularly preferably, a second slip limit value is specified and assigned to the second actuator arrangement, wherein the second slip limit value is in particular greater than the first slip limit value, and, if the actual slip value at least reaches, in particular exceeds, the second slip limit value, the second actuator arrangement is actuated for generating an additional hydraulic braking torque. The corresponding specification and use of the second slip limit value results in the advantage that the second actuator arrangement is reliably engaged in a slip situation defined by the limit value, in order to assist the first actuator arrangement in fulfilling the brake request. For example, the second slip limit value is defined depending on a performance capability of the first actuator arrangement in order to ensure that the first actuator arrangement is not overloaded, by engaging the second actuator arrangement in time. The slip limit value is used in this respect to determine the fraction of the braking torque that is to be provided via the first actuator arrangement or its electric machine. Here, the slip limit value also defines an upper limit for the braking torque. Only braking torque fractions that exceed this limit are provided by means of the second actuator arrangement and thus by means of the hydraulic wheel braking device.

According to a preferred development of the present disclosure, a third slip limit value is specified, in particular in an unstable range of a wheel slip curve, and is assigned to the first actuator arrangement, wherein the third slip limit value is in particular greater than the first and/or the second slip limit value, and, if the actual slip value at least reaches, in particular exceeds, the third slip limit value, the first actuator arrangement is actuated for maintaining the third slip limit value, in particular for reducing the actual slip value to the third slip limit value. The corresponding specification and use of the third slip limit value advantageously ensures that the wheel slip is controlled by means of the first actuator arrangement. If the braking torque fractions provided by the two actuator arrangements lead to a correspondingly high wheel slip, an attempt is made, when the corresponding third slip limit value is exceeded, to keep the wheel at the desired wheel slip by means of the first actuator arrangement, in particular by means of a speed specification to the electric machine. In particular, this desired wheel slip characterized by the third slip limit value corresponds to an optimal wheel slip for fulfilling the brake request.

According to an example embodiment, particularly preferably, a speed limit value for the electric machine of the first actuator arrangement is specified depending on the third slip limit value, and the electric machine is actuated depending on the speed limit value by means of a speed control. Such a speed control results in the advantage that the wheel slip can be controlled particularly precisely.

According to a preferred development of the present disclosure, a fourth slip limit value is specified and assigned to the second actuator arrangement, wherein the fourth slip limit value is in particular greater than the first, the second and/or the third slip limit value, and, if the actual slip value at least reaches, in particular exceeds, the fourth slip limit value, the second actuator arrangement, in particular the hydraulic valve arrangement, is actuated for maintaining the fourth slip limit value, in particular for reducing the actual slip value to the fourth slip limit value. The corresponding specification and use of the fourth slip limit value advantageously ensures that, if the first actuator arrangement fails to keep the wheel slip near its assigned slip limit value, the second actuator arrangement will perform an assisting control in order to ensure driving safety at all times. In this respect, the second actuator arrangement carries out a control of the wheel slip in the further course of the wheel slip control only as needed, i.e., only if the fourth slip limit value is exceeded. Only then is the hydraulic brake controlled via the slip control.

According to an example embodiment, particularly preferably, the actuation for maintaining the third and/or the fourth slip limit value is terminated as soon as the actual slip value falls below the corresponding slip limit value. The corresponding termination of the actuation for maintaining the particular limit value(s) results in the advantage that the method is performed particularly efficiently. In particular, this is performed stepwise, i.e., as soon as the fourth slip limit value is fallen below again, the slip control by means of the second actuator arrangement stops and the wheel slip continues to be controlled by means of the first actuator arrangement, for example, via the aforementioned speed specification to the electric machine. If, in the further course of the slip control, the third slip limit value is also fallen below, this control is also terminated.

A computer program product according to the present disclosure for execution on a computer device carries out the method according to the present disclosure when used as intended. This results in the aforementioned advantages.

A machine-readable storage medium according to the present disclosure includes the computer program product according to the present disclosure stored thereon.

A computer device according to the present disclosure is specifically configured to execute the computer program product according to the present disclosure or to perform the method according to the present disclosure. This, too, results in the aforementioned advantages. Preferably, the computer device is a control apparatus and/or control unit assigned to a motor vehicle, in particular arranged in the motor vehicle.

Further preferred features and combinations of features result from what is disclosed herein. Example embodiments of the present disclosure are explained in more detail below with reference to the figures.

### BRIEF DESCRIPTION OF THE DRAWINGS

FIG. 1 shows an advantageous example method for operating a motor vehicle, according to the present disclosure.

FIG. 2 shows a first example of torque and slip profiles during the performance of the method.

FIG. 3 shows a second example of the torque and slip profiles.

FIG. 4 shows a third example of the torque and slip profiles.

### DETAILED DESCRIPTION OF EXAMPLE EMBODIMENTS

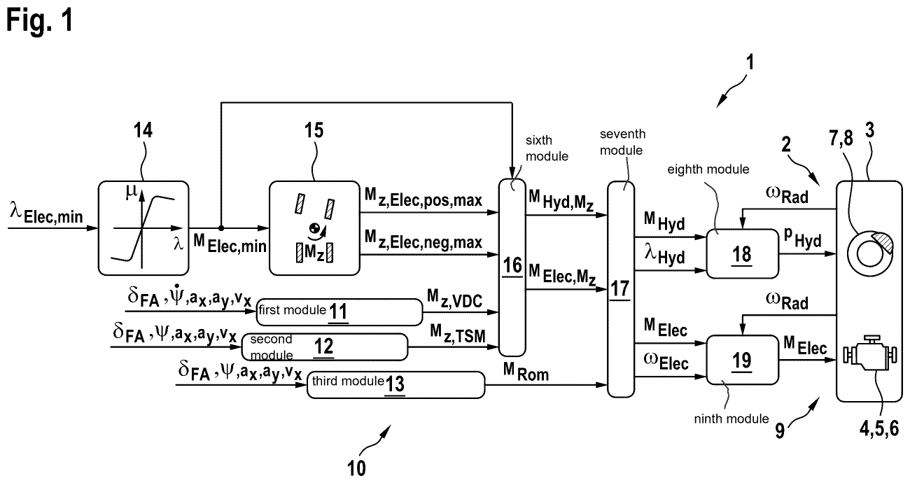

FIG. 1 shows an advantageous example method for operating a motor vehicle 1 on the basis of a block diagram with the mechanisms for actuating a wheel combination actuator of the motor vehicle 1 by means of lateral dynamic stabilization functions. The components involved are only indicated schematically.

The motor vehicle 1 comprises at least one axle 2 with at least one wheel 3. The motor vehicle 1 also comprises an electric drive device 4 with an actuatable first actuator arrangement 5. The first actuator arrangement 5 comprises an electric machine 6.

The motor vehicle 1 also comprises a hydraulic wheel braking device 7 with an actuatable second actuator arrangement 8 not shown in detail. In particular, the second actuator arrangement 8 comprises a hydraulic pump, an electric machine assigned to the hydraulic pump, and/or a hydraulic valve arrangement. The two actuator arrangements 5, 8 are each assigned to the wheel 3 and are thus part of an aforementioned wheel combination actuator 9.

Lastly, the motor vehicle 1 also comprises at least one computer device 10, which is designed to carry out the method (to be described) at least partially, in particular completely, for example, to actuate the actuator arrangements 5, 8 in a coordinated manner. Preferably, the computer device 10 comprises at least one, in particular all, of the modules described below and/or is designed to carry out at least one of the functions mentioned below and/or to perform corresponding method steps relating to the aforementioned lateral dynamic stabilization functions. The computer device 10 is designed in particular as an electronic control apparatus and/or control unit (ECU).

As already mentioned, FIG. 1 shows the mechanisms for actuating the wheel combination actuator 9 by means of lateral dynamic stabilization functions. Various functions or modules (software and/or hardware), their circuitry with regard to the used input variables and output variables up to the actual wheel combination actuator 9 are shown in order to explain the method according to the present disclosure.

In the present case, the lateral dynamic stabilization functions of the motor vehicle 1 include a yaw rate control, also called vehicle dynamics control (VDC), shown as a first module 11, a trailer stabilization, also called trailer sway mitigation (TSM), shown as a second module 12, and a rollover prevention, also called rollover mitigation (ROM) or roll movement intervention (RMI), shown as a third module 13.

All functions or modules 11-13 use provided sensor signals for measuring vehicle motion (yaw velocity \dot{ψ}, longitudinal acceleration aₓ, lateral acceleration a_{y}, and vehicle velocity vₓ) and a driver steering request (front axle steering angle δ_{FA}) as respective input signals. For the actuation of the wheel combination actuator 9, it is important to know the limit to which the electric machine 6 of the first actuator arrangement 5, i.e., the drive motor, is to be used.

A yaw torque potential for this actuator is determined for this purpose. The yaw torque potential is determined from a physical tire model (for example, the Pacejka tire model described in the related art) and a two-track model for the motor vehicle 1, shown as a common fourth module 14. The tire model receives a slip limit λ_{Elec,min} as an input variable. This slip limit characterizes the slip limit of the wheel 3 when braking by means of the electric machine 6.

A torque limit M_{Elec,min} obtained from the tire model as an output variable is used with the aid of the two-track model in a fifth module 15 as an input variable and is converted there into a first and a second yaw torque limit M_{z,Elec,pos,max} and M_{z,Elec,neg,max} about the vertical axis. The first yaw torque limit M_{z,Elec,pos,max} denotes the maximum possible clockwise (pos) yaw torque, and the second yaw torque limit M_{z,Elec,neg,max} denotes the maximum possible counterclockwise (neg) yaw torque.

These yaw torque limits M_{z,Elec,pos,max} and M_{z,Elec,neg,max} as output variables of the fifth module 15, along with a first yaw torque fraction M_{z,VDC} as an output variable of the first module 11 and a second yaw torque fraction M_{z,TSM} as an output variable of the second module 12, enter a yaw torque distribution shown as the sixth module 16.

In the yaw torque distribution, the yaw torque fractions M_{z,VDC} and M_{z,TSM} as input variables or requirements are compared with the yaw torque limits M_{z,Elec,pos,max} and M_{z,Elec,neg,max} for the electric machine 6.

If the requirements are less than the yaw torque limits M_{z,Elec,pos,max} or M_{z,Elec,neg,max}, the entire requirement is converted into a preliminary first braking torque fraction M_{Elec,M}_{_{z}} for the electric machine 6 of the first actuator arrangement 5. If, on the other hand, one of the yaw torque limits M_{z,Elec,pos,max} or M_{z,Elec,neg,max} is exceeded, a preliminary second braking torque fraction M_{Hyd,M}_{_{z}} for the second actuator arrangement 8 of the hydraulic brake is additionally calculated.

In an actuator arbitration shown as the seventh module 17, all braking torque fractions of the lateral dynamic stabilization functions for the wheel combination actuator 9 converge. Here, the preliminary first braking torque fraction M_{Elec,M}_{_{z}} and the preliminary second braking torque fraction M_{Hyd,M}_{_{z}} as output variables of the sixth module 16 as well as a third braking torque fraction M_{Rom} as an output variable of the third module 13 are used as respective input variables.

In the modules 16 and 17, in a first step, it is defined depending on a brake request how high a total braking torque M_{Rad} is at the wheel 3. In a further step, it is defined which actual or final braking torque fraction M_{Elec} is passed to the electric machine 6 of the first actuator arrangement 5 and which final braking torque fraction M_{Hyd} is passed to the second actuator arrangement 8 of the hydraulic brake. This is done in the present case with the torque limit M_{Elec,min}, which is obtained from the tire model as an output variable, as a further input variable to the module 17. The sum of the two braking torque fractions corresponds to the braking torque M_{Rad} at the wheel 3.

The structure selected here, in particular the functional division between the modules 16 and 17, results from a functional architecture with the goal of separating requirements at the vehicle level (yaw torque) and at the wheel level (wheel torque). As a result, vehicle dynamic stabilization functions can be advantageously coordinated at the right locations.

A subordinate slip control for the second actuator arrangement 8, shown as an eighth module 18, receives as input variables from the seventh module 17 the final second braking torque fraction M_{Hyd}, a slip limit λ_{Hyd}, as well as from the wheel 3 a wheel speed ω_{Rad} for controlling a hydraulic pressure p_{Hyd}, and a subordinate speed control for the electric machine 6 of the first actuator arrangement 5, shown as a ninth module 19, receives as input variables from the seventh module 17 the final first braking torque fraction M_{Elec}, a speed limit ω_{Elec} resulting from a slip limit λ_{Rad,lim}, as well as from the wheel 3 the wheel speed ω_{Rad} for controlling the braking torque fraction M_{Elec}. Both subordinate controllers ensure that the requested limits are maintained.

In this respect, the modules 17 to 19 are the core of the method according to the present disclosure, which is to be described below. Each of the actuator arrangements 5, 8 is assigned at least one, in particular wheel-specific, slip limit value, i.e., in the present case, at least the first actuator arrangement 5 is assigned the slip limit λ_{Rad,lim} as a slip limit value and the second actuator arrangement 8 is assigned the slip limit λ_{Hyd} as a further slip limit value. The slip limit λ_{Elec,min} is also taken into account as a further slip limit value. In addition, the actuator arrangements 5, 8 are actuated depending on the respective specified slip limit values, for fulfilling a brake request.

Three examples are used to explain how the braking torque distribution is carried out by means of the actuator arbitration in the module 17 and the corresponding control is carried out by means of the slip control and the speed control in the modules 18 and 19 as part of the method.

At least four different slip limit values are used, including the three aforementioned slip limit values. For the sake of simplicity, these slip limit values are numbered in ascending order of their value below, the numbering serving only to differentiate them but not to prioritize or specify them and not implying any necessary dependence of the limit values on one another.

Preferably, at least one of the slip limit values is specified depending on a performance capability of the corresponding actuator arrangement 5, 8 and/or on a driving mode of the motor vehicle 1, in particular comprising a comfort mode and/or a sports mode.

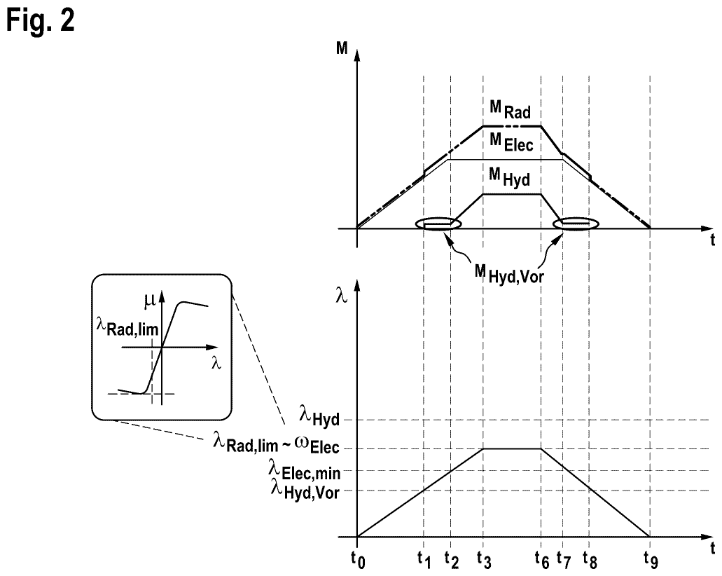

FIGS. 2 to 4 each show torque and slip profiles during the performance of the method in different driving situations. FIGS. 2 to 4 each show a profile diagram of torques M over time t in an upper half and a profile diagram of a wheel slip λ over time t in a lower half.

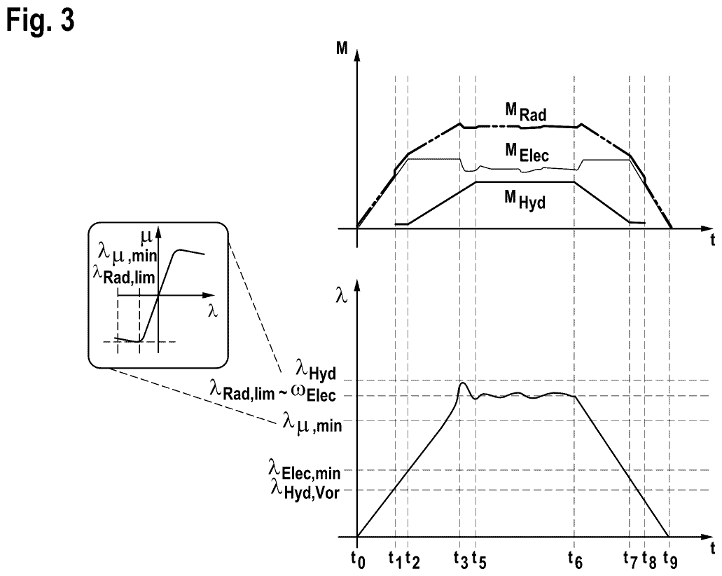

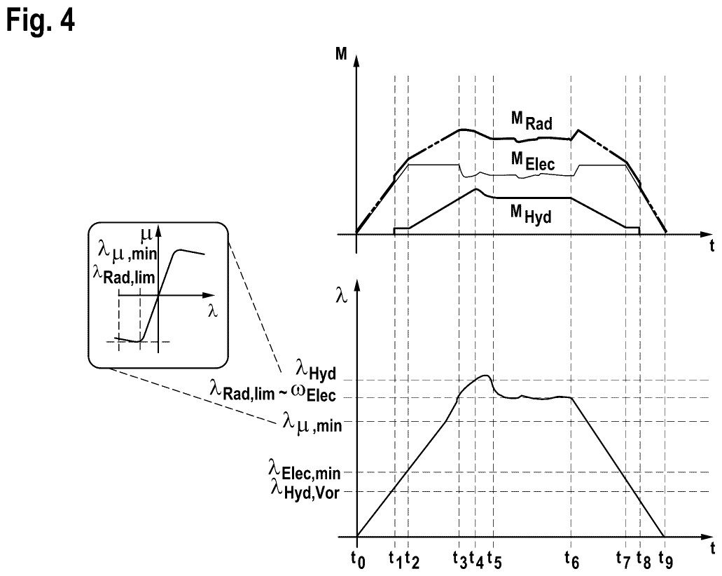

FIG. 2 shows a first example with a time profile of the braking torque distribution with a stable wheel slip profile. FIG. 3 shows a second example with a time profile of the braking torque distribution with an unstable wheel slip profile and active (electric) speed control. FIG. 4 shows a third example with a time profile of the braking torque distribution with an unstable wheel slip profile and active (hydraulic) slip control and (electric) speed control.

The numbering of the times described below is selected such that at least approximately the same happens at the same times in order to be better able to compare the examples shown.

The motor vehicle is initially monitored for a brake request. In each case, an actual slip value of the wheel slip λ is ascertained and, as soon as a corresponding brake request has been detected, only the first actuator arrangement 5 is actuated depending on the actual slip value, in particular by means of a speed control of the electric machine 6, for generating an electrical braking torque.

That is to say, the process is in each case started with actuation of the electric machine 6 of the first actuator arrangement 5 at time t₀. An increasing first braking torque fraction M_{Elec} is applied to the electric machine 6. The wheel slip consequently also increases. The first braking torque fraction M_{Elec} corresponds to the electrical braking torque.

A first slip limit value is now specified and assigned to the second actuator arrangement 8. If the actual slip value at least reaches, in particular exceeds, the first slip limit value, the second actuator arrangement 8, in particular the electric machine assigned to the hydraulic pump, is additionally actuated for prefilling a hydraulic circuit of the wheel braking device 7.

It can be seen in FIG. 2 that, from time t₁, at which a slip limit λ_{Hyd,Vor} is reached, an additional constant braking torque M_{Hyd,Vor} is specified for the hydraulic wheel braking device 7 and hydraulic prefilling takes place until time t₂. Possible weaknesses of the hydraulic wheel braking device 7 in the pressure buildup are thereby avoided. The slip limit λ_{Hyd,Vor} corresponds to the first slip limit value.

It is selected in particular to be so high that reliable application of the brake pads is possible. For example, it is defined depending on a value of a hydraulic pressure, in particular in a range up to 10 bar, for example 5 bar, and/or on a cp characteristic value of the friction brake.

Furthermore, a second slip limit value is specified and assigned to the second actuator arrangement 8. If the actual slip value at least reaches, in particular exceeds, the second slip limit value, the second actuator arrangement 8 is actuated for generating an additional hydraulic braking torque.

Otherwise, until time t₂, electric control is applied exclusively, i.e., the first actuator arrangement 5 is used, up to the slip limit λ_{Elec,min} already used in the tire model. The slip limit λ_{Elec,min} thus corresponds to the second slip limit value. The second slip limit value is therefore greater than the first slip limit value.

The actuation of the electric machine is carried out in particular with a target torque, which results from the slip limit. The slip limit results in a maximum torque. If the total brake request is within this range, this maximum torque is provided as the target torque.

The slip limit λ_{Elec,min} is reached or exceeded at time t₂. A further increasing second braking torque fraction M_{Hyd} is now applied to the hydraulic wheel braking device 7 by the second actuator arrangement 8, and hydraulic control is thus applied. The second braking torque fraction M_{Hyd} corresponds to the additional hydraulic braking torque.

Furthermore, a third slip limit value is specified and assigned to the first actuator arrangement 5. If the actual slip value at least reaches, in particular exceeds, the third slip limit value, the first actuator arrangement 5 is actuated for maintaining the third slip limit value, in particular for reducing the actual slip value to the third slip limit value.

It can be seen in FIG. 2 that the actuation of the second actuator arrangement 8 is carried out up to a slip limit λ_{Rad,lim}, which is reached at time t₃. Because this slip limit is not exceeded, there is also no control by the first actuator arrangement 5. The slip limit λ_{Rad,lim} corresponds to the third slip limit value. The third slip limit value is therefore greater than the first and the second slip limit value.

In the described example, the total brake request is higher than the maximum torque for the electric machine 6 so that the remaining torque fraction is specified as the target torque for the wheel braking device 7. The target slip for the machine 6 is limited by the slip limit λ_{Elec,min} to a defined slip range. The target slip for the wheel braking device 7 results from a defined increase of the slip limit λ_{Elec,min} to the slip limit λ_{Rad,lim}.

The specification of the particular target slip for the corresponding actuator arrangement 5, 8 serves in particular only to safeguard the torque specification. The actuation signal for the particular actuator arrangement 5, 8 is then always the torque. Only in the case of a wheel slip above the target slip specification for the particular actuator arrangement 5, 8 will a subordinate wheel controller become active and limit the wheel slip to the target slip specification. This is described in detail in FIGS. 3 and 4.

A speed limit value for the electric machine 6 of the first actuator arrangement 5 is also specified depending on the third slip limit value, and the electric machine 6 is actuated depending on the speed limit value by means of a speed control when the third slip limit value is reached or exceeded.

The slip limit λ_{Rad,lim} results in the aforementioned speed limit ω_{Elec} for the electric machine 6. The speed limit ω_{Elec} corresponds to the speed limit value for the electric machine 6.

Finally, a fourth slip limit value is specified and assigned to the second actuator arrangement 8. If the actual slip value at least reaches, in particular exceeds, the fourth slip limit value, the second actuator arrangement 8, in particular the hydraulic valve arrangement, is actuated for maintaining the fourth slip limit value, in particular for reducing the actual slip value to the fourth slip limit value.

In the present case, for this purpose, the aforementioned slip limit λ_{Hyd} is additionally specified, which is always higher than the slip limit λ_{Rad,lim} and is preferably implemented with a defined offset to the slip limit λ_{Rad,lim}. The slip limit λ_{Hyd} corresponds to the fourth slip limit value. The fourth slip limit value is therefore greater than the first, the second, and the third slip limit value. Both slip limits λ_{Rad,lim} and λ_{Hyd} are maintained in the present case so that no corresponding control is necessary.

In FIG. 2, the slip limit λ_{Rad,lim} is in a linear or stable range of the slip curve of the wheel 3, as indicated in a detail next to the wheel slip profile. The slip and the mentioned torques are kept constant until time t₆ and then reduced again.

It can be seen in FIG. 2 that the braking torque distribution process is carried out in the reverse order from time t₆ when the total braking torque M_{Rad} decreases. First, the second braking torque fraction M_{Hyd} is reduced by time t₇ to the mentioned constant braking torque M_{Hyd,Vor} for prefilling.

Thereafter, the first braking torque fraction M_{Elec} is reduced. The timing and duration of the reduction of individual braking torque fractions result from the slip limits already described. Thus, at time t₈, the slip limit λ_{Hyd,Vor} is reached again and the additional braking torque M_{Hyd,Vor} is omitted. Finally, at time t₉, the brake request is completely fulfilled and the first braking torque fraction M_{Elec} is reduced to zero.

The braking torque distribution shown in FIG. 2 indicates that, as a result of the order, the requirements of the lateral dynamic stabilization functions can be carried out even earlier than before and without the driver noticing, since the electric machine 6 of the drive device 4 is used first. The wheel braking device 7 is also optimally included by improving the pressure buildup dynamics through prefilling and by the noticeable NVH behavior of the brake hydraulics occurring only at a later time.

FIG. 3 again shows the braking torque distribution already described. Electric control is likewise applied from time t₀ to time t₂, hydraulic prefilling is carried out from time t₁ to time t₂, and hydraulic control is applied from time t₂.

Because the slip limit λ_{Rad,lim} is now in an unstable range of the slip curve below the critical or minimum slip value λ_{μ,min}, an unstable wheel slip profile occurs in the range of the hydraulic control. At time t₃, the slip limit λ_{Rad,lim} is therefore exceeded during the hydraulic control. This is followed by a phase of the electric control of the machine 6 to the speed limit ω_{Elec} in order to be able to maintain the slip limit λ_{Rad,lim}.

Thus, the case described above has occurred, in which the actual slip value exceeds the third slip limit value. Accordingly, the first actuator arrangement 5 is actuated, in the present case depending on the speed limit value by means of a speed control, for maintaining the third slip limit value, in particular for reducing the actual slip value to the third slip limit value.

At time t₅, the slip limit λ_{Rad,lim} is at least approximately maintained again, or the wheel slip only fluctuates slightly around the slip limit λ_{Rad,lim} until time t₆. The slip limit λ_{Hyd} is maintained or not exceeded. The speed control is successful in this respect, wherein, between times t₅ and t₆, only the first braking torque fraction M_{Elec} is modulated and the second braking torque fraction M_{Hyd} is kept constant.

Thus, the actuation for maintaining the third slip limit value is terminated as soon as the actual slip value falls below the slip limit value.

Analogously to FIG. 2, from time t₆ to time t₀, the second braking torque fraction M_{Hyd} is reduced to the constant braking torque M_{Hyd,Vor}. The first braking torque fraction M_{Elec} is subsequently reduced, wherein the additional braking torque M_{Hyd,Vor} is omitted at time t₈ and the first braking torque fraction M_{Elec} is reduced to zero at time t₉.

FIG. 4 again shows the braking torque distribution already described. Electric control is applied from time t₀ to time t₂, hydraulic prefilling is carried out from time t₁ to time t₂, and hydraulic control is applied from time t₂.

Because the slip limit λ_{Rad,lim} is again in the unstable range of the slip curve below the minimum slip value λ_{μ,min}, an unstable wheel slip profile occurs in the range of the hydraulic control. At time t₃, the slip limit λ_{Rad,lim} is therefore exceeded during the hydraulic control. This is followed by a phase of the electric control of the machine 6 to the speed limit ω_{Elec} in order to be able to maintain the slip limit λ_{Rad,lim}.

Thus, once again, the case described above has occurred, in which the actual slip value exceeds the third slip limit value. Accordingly, the first actuator arrangement 5 is actuated, in the present case depending on the speed limit value by means of a speed control, for maintaining the third slip limit value, in particular for reducing the actual slip value to the third slip limit value.

However, the instability is so sharply pronounced that the slip limit λ_{Hyd} is also exceeded at time t₄ during the hydraulic control. This is followed by a short phase until time t₅, in which hydraulic control is applied until the wheel slip is again below the slip limit λ_{Hyd}. In parallel, the phase of the electric control takes place in order to maintain the slip limit λ_{Rad,lim} as well. In this respect, both the first braking torque fraction M_{Elec} and the second braking torque fraction M_{Hyd} are modulated between times t₄ and t₅.

Thus, the case described above has also occurred, in which the actual slip value exceeds the fourth slip limit value. Accordingly, the second actuator arrangement 8, in particular the hydraulic valve arrangement, is additionally actuated for maintaining the fourth slip limit value, in particular for reducing the actual slip value to the fourth slip limit value.

After time t₅, the slip limit λ_{Rad,lim} is also at least approximately maintained again, or the wheel slip only fluctuates slightly around the slip limit λ_{Rad,lim} until time t₆. The combined slip control and speed control by means of the two actuator arrangements 5, 8 was successful. Between times t₅ and t₆, again, only the first braking torque fraction M_{Elec} is modulated and the second braking torque fraction M_{Hyd} is kept constant.

The actuation for maintaining the third and the fourth slip limit value is terminated as soon as the actual slip value falls below the corresponding slip limit value.

Analogously to FIGS. 2 and 3, from time t₆ to time t₇, the second braking torque fraction M_{Hyd} is reduced to the constant braking torque M_{Hyd,Vor}. The first braking torque fraction M_{Elec} is subsequently reduced, wherein the additional braking torque M_{Hyd,Vor} is omitted at time t₈ and the first braking torque fraction M_{Elec} is reduced to zero at time t₉.

The examples shown in FIGS. 3 and 4 thus illustrate the wheel slip control strategy according to the present disclosure by the wheel combination actuator 9, which strategy is fully applied in particular if the wheel slip reaches an unstable range, or if a corresponding wheel slip is intentionally allowed, for example in a sports mode; otherwise, none of the limit values relevant to the respective control should be exceeded, as shown in FIG. 2. The selection of the slip limits ensures that the wheel slip is primarily controlled via the electric machine 6. As a result, its properties, such as high dynamics and fast controllability, are advantageously used.

1-13. (canceled)

14. A method for operating a motor vehicle, the motor vehicle including at least one axle with at least one wheel, wherein the wheel is assigned an electric drive device with an actuatable first actuator arrangement including an electric machine, and wherein the wheel is assigned a wheel braking device with an actuatable second actuator arrangement, the method comprising the following steps:
assigning each of the first actuator arrangement and the second actuator arrangement at least one wheel-specific slip limit value, and
actuating the first actuator arrangement and the second actuator arrangement depending on the assigned at least one slip limit values for fulfilling a brake request.

15. The method according to claim 14, wherein: (i) the wheel braking device includes a further electric machine, and/or (ii) the wheel braking device is a hydraulic wheel braking device and includes an electric machine which is assigned to a hydraulic pump and/or a hydraulic valve arrangement.

16. The method according to claim 14, wherein at least one of the at least one slip limit value is specified depending: (i) on a performance capability of a corresponding one of the first actuator arrangement or the second actuator arrangement, and/or (ii) on a driving mode of the motor vehicle including a comfort mode and/or a sports mode.

17. The method according to claim 14, wherein an actual slip value of the wheel slip is ascertained, and wherein only the first actuator arrangement is initially actuated depending on the actual slip value, including using a speed control of the electric machine, for generating an electrical braking torque.

18. The method according to claim 17, wherein a first slip limit value is specified and assigned to the second actuator arrangement, and when the actual slip value reaches or exceeds the first slip limit value, the second actuator arrangement including the electric machine assigned to the hydraulic pump, is additionally actuated for prefilling a hydraulic circuit of the wheel braking device.

19. The method according to claim 18, wherein a second slip limit value is specified and assigned to the second actuator arrangement, wherein the second slip limit value is greater than the first slip limit value, and when the actual slip value at least reaches or exceeds the second slip limit value, the second actuator arrangement is actuated for generating an additional hydraulic braking torque.

20. The method according to claim 19, wherein a third slip limit value is specified in an unstable range of a wheel slip curve, and is assigned to the first actuator arrangement, wherein the third slip limit value is greater than the first and/or the second slip limit value, and when the actual slip value reaches or exceeds the third slip limit value the first actuator arrangement is actuated for maintaining the third slip limit value for reducing the actual slip value to the third slip limit value.

21. The method according to claim 20, wherein a speed limit value for the electric machine of the first actuator arrangement is specified depending on the third slip limit value, and the electric machine is actuated depending on the speed limit value for the electric machine of the first actuator arrangement a speed control.

22. The method according to claim 20, wherein a fourth slip limit value is specified and assigned to the second actuator arrangement, wherein the fourth slip limit value is greater than at least one of the first, the second, or the third slip limit value, and when the actual slip value reaches or exceeds, the fourth slip limit value, a hydraulic valve arrangement of the second actuator arrangement is actuated for maintaining the fourth slip limit value, in particular for reducing the actual slip value to the fourth slip limit value.

23. The method according to claim 22, wherein the actuation for maintaining the third and/or the fourth slip limit value is terminated as soon as the actual slip value falls below the third and/or the fourth slip limit value.

24. A non-transitory machine-readable storage medium on which is stored a computer program for operating a motor vehicle, the motor vehicle including at least one axle with at least one wheel, wherein the wheel is assigned an electric drive device with an actuatable first actuator arrangement including an electric machine, and wherein the wheel is assigned a wheel braking device with an actuatable second actuator arrangement, the computer program, when executed by a computer device, causing the computer device to perform the following steps comprising:
assigning each of the first actuator arrangement and the second actuator arrangement at least one wheel-specific slip limit value, and
actuating the first actuator arrangement and the second actuator arrangement depending on the assigned at least one slip limit values for fulfilling a brake request.

25. A computer device, comprising:
an electronic control apparatus and/or control unit for a motor vehicle, the electronic control apparatus and/or the control unit being configured to execute a computer program for operating a motor vehicle, the motor vehicle including at least one axle with at least one wheel, wherein the wheel is assigned an electric drive device with an actuatable first actuator arrangement including an electric machine, and wherein the wheel is assigned a wheel braking device with an actuatable second actuator arrangement, the computer program, when executed by the electronic control apparatus and/or the control unit, causing the electronic control apparatus and/or the control unit to perform the following steps including:
assigning each of the first actuator arrangement and the second actuator arrangement at least one wheel-specific slip limit value, and
actuating the first actuator arrangement and the second actuator arrangement depending on the assigned at least one slip limit values for fulfilling a brake request.
